(19) United States
(12) Patent Application Publication
(10) Pub. No.: US 2026/0015821 A1
(43) Pub. Date: Jan. 15, 2026

(54) HANDHELD MACHINE FOR CUTTING AND EXCAVATING TRENCHES

(71) Applicant: Dale Arthur Ballenger, Boynton Beach, FL (US)

(72) Inventor: Dale Arthur Ballenger, Boynton Beach, FL (US)

(21) Appl. No.: 18/831,412

(22) Filed: May 10, 2021

(51) Int. Cl. E02F 5/08; A01B 33/02; A01D 34/84; A01D 34/90

(52) U.S. Cl. CPC E02F 5/08; A01B 33/027; A01D 34/84; A01D 34/90

(57) ABSTRACT

The stand-up, handheld machine comprised of a small engine/motor, an extended tubing housing a rotating internal transmission shaft, mounted to a speed reduction box. The speed reduction gearbox transmits rotation and torque to cutting and excavating blades via output shafts. Cutting blades cut and excavate soil to desired depth and width. Operator cuts and excavates trench by linearly moving machine along cutting surface. Operator controls speed of blades through throttle/speed control of power unit.

### BACKGROUND OF THE INVENTION

Installing underground utilities, irrigation, and wiring, is a laborious effort. Modern mechanical trenching equipment is not ergonomically designed for long term use or the design is too large to access tight spaces.

Current trenching machines are bulky and heavy, not able to be lifted and operated under human effort. Other, smaller machines are designed for user to remain at a constant bend of back for operation. Current chain and boom designs on modern day trenching machines are limited by depth capability and contain many moving components that wear under the harsh soil environments.

### BRIEF DESCRIPTION OF THE DRAWINGS

FIGS. 1 and 2 provide schematic views and of an embodiment of the present invention. FIG. 1 shows the full scope of the invention where trenching attachment and blades (3 & 4) are connected to a small engine/motor. The safety deflector (4) attaches between the operator and trenching attachment. FIG. 2 dissects the trenching attachment for the utility of a compact design and V-trench excavation.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

The present invention includes a handheld machine and attachment for cutting and excavating trenches. The trenching attachment (“unit”) installs onto the working end of a handheld machine comprised of a small engine/motor and extended tubing housing a rotating internal shaft. The unit's design packaging is small, compact and light, offering agility in tight working environments as well as ergonomically suited for long durations of use. The invention is designed as a compact system with few moving components that attaches to a handheld machine, creating a lightweight, agile tool for continuous industrial use and reducing operational costs and human effort, while benefiting health.

Power unit proves rotation and torque to the speed reduction gearbox via a transmission shaft inside power transmission tube. Speed reduction gearbox transmits rotation and torque to cutting blades via output shafts. Cutting blades rotate and machine is ready for use. Operator controls speed of blades through throttle/speed control of power unit. Operator lowers rotating cutting blades into soil medium. Cutting blades cut and excavate soil to desired depth. Operator cuts and excavates trench by linearly moving machine along cutting surface.

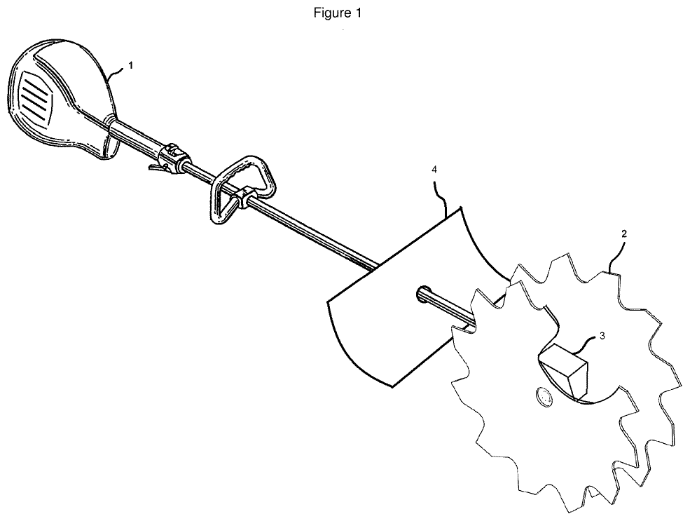

The present invention may include the following parts (see FIG. 1). A dirt deflector (4) is assembled and clamped to the power transmission tube of power unit (1). Speed reduction gearbox (3) is installed and clamped to working end of the power unit (1). Cutting blades (2) are mounted to output shafts of speed reduction gearbox (3).

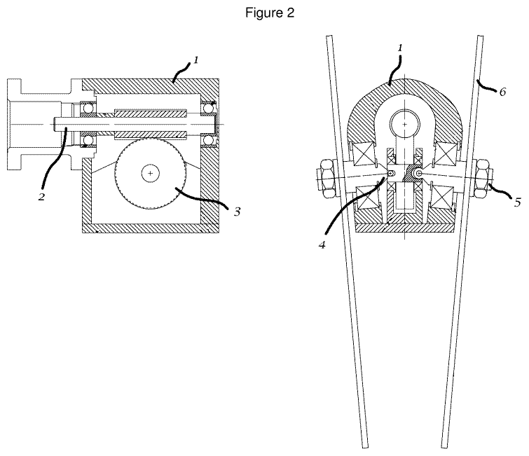

1. Reviewing FIG. 2—The gearbox (1) is comprised of an input gear (2), a translating gear (3), swivel joint (4), output shafts (5) extending outside the gearbox, and the cutting and excavating blades (6).
The cutting blades are in a V-shape design to cut and excavate, providing the utility of a draft angle for reduced cutting media fall-in and deep trench access.
This invention and tool could also be used as a garden edger, for footer ground installation and removal, bed edger, root pruner, irrigation installation, ground wiring, and tiller.
The invention described above is for purposes of example only, and may be implemented in different sizes or using different materials. For clarity, only those aspects of the machine germane to the invention are described, and product details well known in the art are omitted. For the same reason, other components may not be described in further detail. It should thus be understood that the invention is not limited to any specific material, design or size. It is further contemplated that the some parts of the present invention may be used separately or as components for a different machine. In addition, many embodiments of the present invention have application to a wide range of industries.
It should be understood, of course, that the foregoing relates to exemplary embodiments of the invention and that modifications may be made without departing from the spirit and scope of the invention.
